(19) United States
(12) Patent Application Publication
(10) Pub. No.: US 2016/0132232 A1
(43) Pub. Date: May 12, 2016

(54) ELECTRONIC DEVICE AND METHOD FOR PROCESSING HANDWRITTEN DOCUMENT DATA

(71) Applicant: Kabushiki Kaisha Toshiba, Tokyo (JP)

(72) Inventors: Kunio Baba, Ome Tokyo (JP); Junichi Nagata, Tsurugashima Saitama (JP)

(21) Appl. No.: 14/997,974

(22) Filed: Jan. 18, 2016

Related U.S. Application Data
(63) Continuation of application No. PCT/JP2013/082851, filed on Dec. 6, 2013.

(51) Int. Cl. G06F 3/0488; G06F 3/0484

(52) U.S. Cl. CPC G06F 3/04883; G06F 3/04842

(57) ABSTRACT

According to one embodiment, an electronic device detects a first stroke made on a display area of a first document and displays the first stroke on a screen. The electronic device determines at least one handwriting candidate from different handwriting stored in a memory in response to an input of the first stroke, and displays the at least one handwriting candidate on the screen. The electronic device receives a selection of a first handwriting candidate from the at least one handwriting candidate, and determines a first size of the first handwriting candidate according to a size of a second handwritten character string followed by the first stroke. The electronic device inputs the first handwriting candidate in place of the first stroke to the first document according to the first size.

### CROSS-REFERENCE TO RELATED APPLICATIONS

This application is a Continuation application of PCT Application No. PCT/JP2013/082851, filed Dec. 6, 2013, the entire contents of which are incorporated herein by reference.

### FIELD

Embodiments described herein relate generally to a technique for processing handwritten document data.

### BACKGROUND

In recent years, various types of electronic devices such as tablet computers, PDAs and smartphones have been developed. Most of these devices comprise a touchscreen display for enabling the user to easily input data.

In addition, recently, electronic devices capable of dealing with handwritten character strings have been developed.

However, the conventional technique does not consider a technique for smoothly inputting handwritten character stings.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an electronic device according to an embodiment.

FIG. 2 exemplarily shows the cooperative operation between the electronic device of FIG. 1 and an external device.

FIG. 3 shows an example of a document handwritten on a touchscreen display of the electronic device of FIG. 1.

FIG. 4 is exemplarily shown for explaining time-series data which is generated by the electronic device of FIG. 1 and corresponds to the handwritten document of FIG. 3.

FIG. 5 is an exemplary block diagram showing a system configuration of the electronic device of FIG. 1.

FIG. 6 is an exemplary block diagram showing a function structure of a handwritten note application program executed by the electronic device of FIG. 1.

FIG. 7 is exemplarily shown for explaining examples of stroke candidates displayed by the electronic device of FIG. 1.

FIG. 8 is exemplarily shown for explaining examples of stroke candidates which are newly displayed by the electronic device of FIG. 1 when strokes are further input in the state of FIG. 7.

FIG. 9 is exemplarily shown for explaining an operation for completing a handwritten stroke by the electronic device of FIG. 1.

FIG. 10 is exemplarily shown for explaining an operation for adjusting the size and the character interval of the selected stroke candidate (handwritten character string) by the electronic device of FIG. 1.

FIG. 11 is exemplarily shown for explaining an operation for calculating the average character interval of the stroke string (handwritten character string) preceding the input strokes.

FIG. 12 is exemplarily shown for explaining an operation for adjusting the size and the start position of the selected stroke candidate (handwritten character string) by the electronic device of FIG. 1.

FIG. 13 is exemplarily shown for explaining an operation for adjusting the character interval of the selected stroke candidate (handwritten character string) by the electronic device of FIG. 1.

FIG. 14 exemplarily shows a handwritten character string in which the character interval is adjusted.

FIG. 15 is an exemplary flowchart for explaining the procedure of a process for completing a handwritten stroke by the electronic device of FIG. 1.

### DETAILED DESCRIPTION

Various embodiments will be described hereinafter with reference to the accompanying drawings.

In general, according to one embodiment, an electronic device includes a display, a memory and a hardware processor. The display is capable of detecting a stroke made on a screen of the display and displaying the stroke on the screen. The memory is configured to store different handwriting. The hardware processor displays a first document on the screen. The hardware processor detects a first stroke made on a display area of the first document. The hardware processor displays the first stroke on the screen. The hardware processor determines at least one handwriting candidate from the different handwriting in response to an input of the first stroke. The hardware processor displays the at least one handwriting candidate on the screen. The hardware processor receives a selection of a first handwriting candidate from the at least one handwriting candidate. The hardware processor determines a first size of the first handwriting candidate according to a size of a second handwritten character string followed by the first stroke. The hardware processor inputs the first handwriting candidate in place of the first stroke to the first document according to the first size.

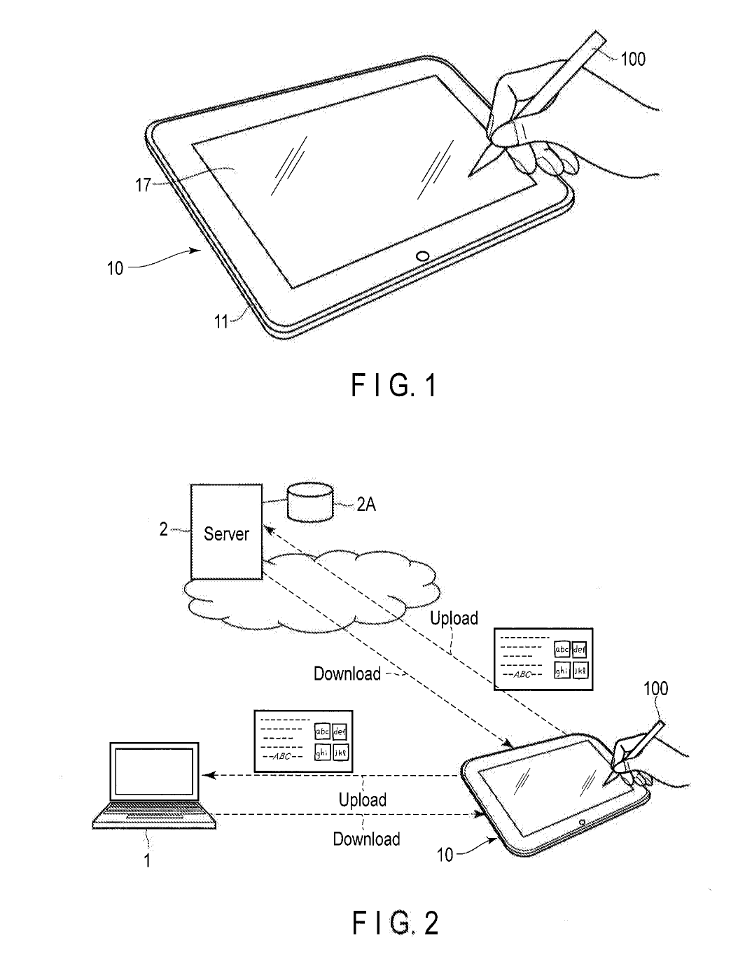

FIG. 1 is a perspective view showing the external appearance of an electronic device according to an embodiment. The electronic device is, for example, a pen-based portable electronic device which enables the user to input data in handwriting by a pen (stylus) or a finger. The electronic device may be realized as, for example, a tablet computer, a notebook computer, a smartphone or a PDA. In the explanation below, this specification assumes that the electronic device is realized as a tablet computer 10. The tablet computer 10 is a portable electronic device which is also called a tablet or a slate computer. As shown in FIG. 1, the tablet computer 10 comprises a main body 11 and a touchscreen display 17. The main body 11 comprises a thin-box-shaped housing. The touchscreen display 17 is attached so as to overlap the upper surface of the main body 11.

A flat-panel display and a sensor are incorporated into the touchscreen display 17. The sensor is configured to detect the contact position on the screen of the flat-panel display with a pen or a finger. The flat-panel display may be, for example, a liquid crystal display (LCD). For the sensor, for example, a capacitive touchpanel or an electromagnetic induction type of digitizer may be used. In the explanation below, this specification assumes that both of the two sensors, which are a digitizer and a touchpanel, are incorporated into the touchscreen display 17.

For example, the digitizer is allocated under the screen of the flat-panel display. For example, the touchpanel is allocated on the screen of the flat-panel display. The touchscreen display 17 is capable of detecting a touch operation with a finger relative to the screen as well as a touch operation with a pen (stylus) 100 relative to the screen. The pen 100 may be, for example, a digitizer pen (a type of pen using electromagnetic induction). The user can perform a handwriting input operation on the touchscreen display 17, using an external object (the pen 100 or a finger). During the handwriting input operation, the locus of movement of the external object (the pen 100 or the finger) on the screen is drawn in real time. In other words, the locus of each stroke which is input by handwriting is drawn in real time. In this manner, the locus of each stroke is displayed on the screen. The locus of movement of the external object in the period of contact of the external object on the screen is equivalent to one stroke. The assembly of many strokes corresponding to handwritten characters, figures, etc., constitutes a handwritten document. In other words, the assembly of many loci (strokes) constitutes a handwritten document.

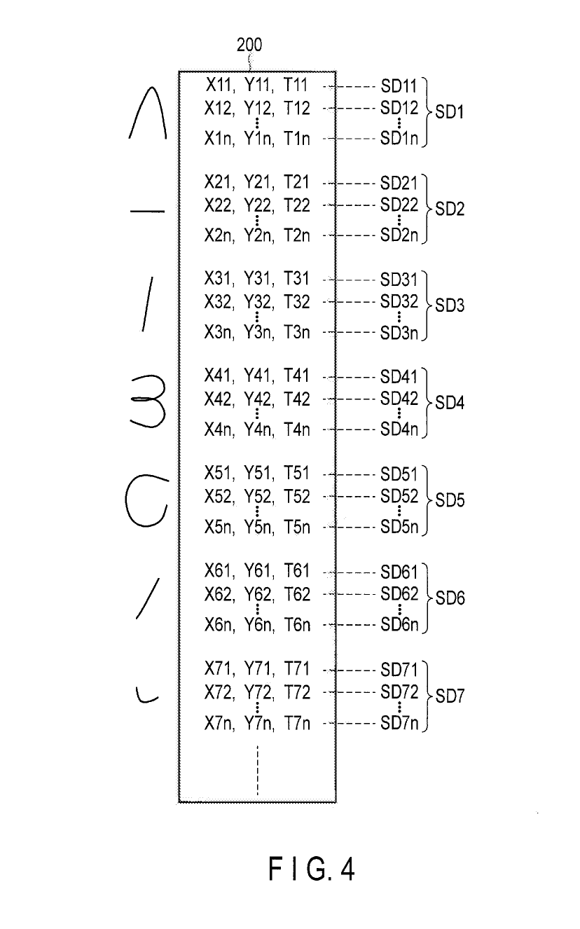

In the present embodiment, the handwritten document is not stored as image data. Instead, the handwritten document is stored in a storage medium as time-series data indicating the coordinate series of the locus of each stroke and the order relationships of strokes. The detail of time-series data is explained later with reference to FIG. 4. Briefly speaking, time-series data indicates the order in which a plurality of strokes were handwritten, and includes a plurality of stroke data items corresponding to a plurality of strokes, respectively. In other words, time-series data means the assembly of time-series stroke data items corresponding to a plurality of strokes, respectively. Each stroke data item corresponds to a stroke and includes a series of coordinate data items (time-series coordinates) each corresponding to a point on the locus of the stroke. The order in which the stroke data items are arranged is equivalent to the order in which the strokes were made, in other words, the writing order.

The tablet computer 10 is capable of reading an arbitrary existing time-series data item (handwritten document data item) from the storage medium and displaying a handwritten document corresponding to the time-series data item on the screen. In other words, the tablet computer 10 is capable of displaying the loci respectively corresponding to a plurality of strokes indicated by the time-series data item on the screen. The tablet computer 10 further has an edit function. For example, the edit function allows the user to delete or move an arbitrary stroke, an arbitrary handwritten character, etc., in the handwritten document displayed in progress in accordance with a user's edit operation using an eraser tool, a range selection tool or other various tools. The edit function further includes a function for undoing the history of some handwriting operations.

The tablet computer 10 further has a handwriting-complete function for completing a stroke (in other words, a function for suggesting a stroke). The handwriting-complete function is a function for assisting the user in his/her handwriting input operation such that a large number of character strings can be easily input in handwriting.

FIG. 2 shows an example of the cooperative operation between the tablet computer 10 and an external device. The tablet computer 10 is capable of cooperating with a personal computer 1 and a cloud. The tablet computer 10 comprises a wireless communication device such as a wireless LAN and is capable of wirelessly communicating with the personal computer 1. The tablet computer 10 is also capable of communicating with a server 2 on the Internet. The server 2 may be a server which executes an online storage service and other various cloud computing services.

The personal computer 1 comprises a storage device such as a hard disk drive (HDD). The tablet computer 10 is capable of transmitting time-series data (a handwritten document) to the personal computer 1 via a network and storing the data on the HDD of the personal computer 1 (this process may be referred to as uploading).

In this manner, even when the capacity of the storage of the tablet computer 10 is small, the tablet computer 10 is capable of dealing with a large number of time-series data items (handwritten documents) or a large volume of time-series data items (handwritten documents).

Moreover, the tablet computer 10 is capable of reading at least one arbitrary handwritten document stored on the HDD of the personal computer 1 (this process may be referred to as downloading). The tablet computer 10 is capable of displaying the locus of each of the strokes indicated by the read document on the screen of the touchscreen display 17 of the tablet computer 10. In this case, a list of thumbnails obtained by scaling down the pages of handwritten documents, respectively, may be displayed on the screen of the display 17, or one page selected from the thumbnails may be displayed on the screen of the touchscreen display 17 in the normal size.

As described above, the other party with which the tablet computer 10 communicates may not be the personal computer 1 and may be the server 2 on the cloud which provides a storage service, etc. The tablet computer 10 is capable of transmitting a handwritten document to the server 2 via a network and storing the document in a storage device 2A of the server 2 (this process may be referred to uploading). The tablet computer 10 is also capable of reading an arbitrary handwritten document stored in the storage device 2A of the server 2 (this process may be referred to as downloading). The tablet computer 10 is capable of displaying the locus of each of the strokes indicated by the read document on the screen of the touchscreen display 17 of the tablet computer 10.

In the present embodiment, the storage medium in which a handwritten document is stored may be any one of the storage device of the tablet computer 10, the storage device of the personal computer 1 and the storage device of the server 2.

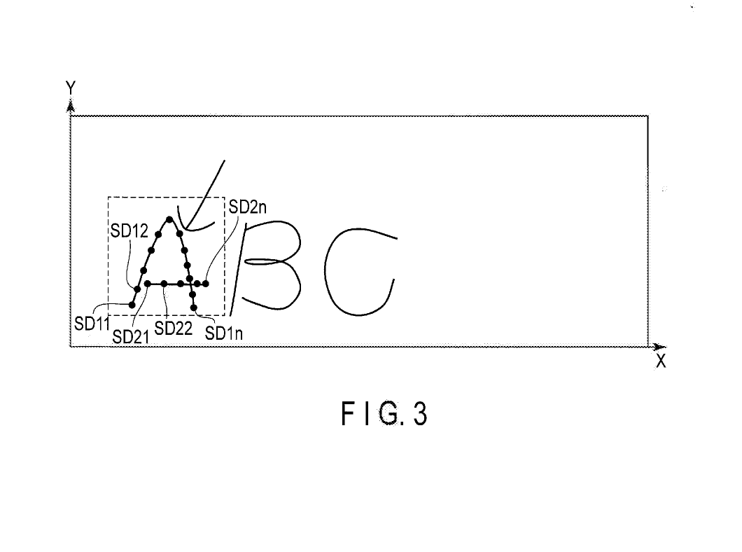

Now, this specification explains the relationship between strokes (characters, marks, figures [diagrams], tables, etc.) made by the user and a handwritten document, referring to FIG. 3 and FIG. 4. FIG. 3 shows an example of a character string handwritten on the touchscreen display 17 with the pen 100, etc.

In many cases, a character or figure is handwritten in a document, and another character or figure is handwritten on the character or figure which has been already written. In FIG. 3, the character string “ABC” is handwritten in the order of “A”, “B” and “C”, and subsequently, an arrow is handwritten in vicinity to the handwritten character “A”.

The handwritten character “A” is shown by two strokes (the locus in the form of “̂” and the locus in the form of “-”) made with the pen 100; in short, by two loci. For example, the first locus of the pen 100 in the form of “̂” is sampled in real time at equal time intervals. Through this process, the time-series coordinates (SD11, SD12, . . . , SD1n) of the stroke in the form of “̂” are obtained. The subsequent locus of the pen 100 in the form of “-” is also sampled in real time at equal time intervals. Through this process, the time-series coordinates (SD21, SD22, . . . , SD2n) of the stroke in the form of “-” are obtained.

The handwritten character “B” is shown by two strokes made with the pen 100, etc.; in short, by two loci. The handwritten character “C” is shown by one stroke made with the pen 100, etc.; in short, by one locus. The handwritten arrow is shown by two strokes made with the pen 100, etc.; in short, by two loci.

FIG. 4 shows time-series data 200 corresponding to the handwritten character string shown in FIG. 3. The time-series data 200 includes a plurality of stroke data items SD1, SD2, . . . , SD7. In the time-series data 200, stroke data items SD1, SD2, . . . , SD7 are arranged in the writing order; that is, the chronological order in which the strokes were made.

In the time-series data 200, the first two stroke data items (SD1 and SD2) indicate the two strokes of the handwritten character “A”. The third and fourth stroke data items (SD3 and SD4) indicate the two strokes constituting the handwritten character “B”. The fifth stroke data item (SD5) indicates the stroke constituting the handwritten character “C”. The sixth and seventh stroke data items (SD6 and SD7) indicate the two strokes constituting the handwritten arrow.

Each stroke data item includes a series of coordinate data items (time-series coordinates) corresponding to one stroke. In other words, each stroke data item includes a plurality of coordinates corresponding to a plurality of points on the locus of one stroke, respectively. In each stroke data item, a plurality of coordinates are arranged in the chronological order in which the stroke was made. For example, with regard to the handwritten character “A”, stroke data item SD1 includes a series of coordinate data items (time-series coordinates) each corresponding to a point on the locus of the stroke in the form of “̂” of the handwritten character “A”. In other words, stroke data item SD1 includes n coordinate data items (SD11, SD12, . . . , SD1n). Stroke data SD2 includes a series of coordinate data items each corresponding to a point on the locus of the stroke in the form of “-” of the handwritten character “A”. In other words, stroke data item SD2 includes n coordinate data items (SD21, SD22, . . . , SD2n). The number of coordinate data items may differ depending on the stroke data item. Thus, the locus of the pen 100 is sampled in real time at equal time intervals. Therefore, the longer the stroke is, or the more slowly the stroke is made, the more coordinate data items are obtained.

Each coordinate data item indicates the X- and Y-coordinates corresponding to a point on the corresponding locus. For example, coordinate data item SD11 indicates the X-coordinate (X11) and the Y-coordinate (Y11) of the starting point of the stroke in the form of “̂”. SD1n indicates the X-coordinate (X1n) and the Y-coordinate (Y1n) of the end point of the stroke in the form of “̂”.

Each coordinate data item may further include timestamp data T corresponding to the time when the point corresponding to the coordinates was handwritten. The time when the point was handwritten may be an absolute time (for example, year/month/day/hour/minute/second) or a relative time based on a time point. For example, the absolute time (for example, year/month/day/hour/minute/second) when the user started writing a stroke may be added as timestamp data to the corresponding stroke data item. The relative time indicating the difference from the absolute time may be added as timestamp data T to each coordinate data item of the stroke data item.

It is possible to further accurately show the temporal relationships between strokes by using time-series data in which timestamp data T is added to each coordinate data item.

Moreover, data Z indicating the writing pressure may be added to each coordinate data item.

The time-series data 200 having the structure explained in FIG. 4 is allowed to show the temporal relationships between strokes as well as the path of each stroke. The use of the time-series data 200 allows the handwritten character “A” and the apical end portion of the handwritten arrow to be dealt with as a character and a figure different from each other even when the apical end portion of the handwritten arrow overlaps or is close to the handwritten character “A” as shown in FIG. 3. Timestamp data T may be used as option data. A plurality of stroke data items each of which does not include timestamp data T may be used as the above time-series data.

In the present embodiment, as described above, a handwritten document is not stored as an image or the result of character recognition. Instead, a handwritten document is stored as the assembly of time-series stroke data items. Therefore, handwritten characters can be dealt with without relying on the language of the characters. Thus, the structure of the time-series data 200 of the present embodiment is allowed to be used in common with various countries using different languages in the world.

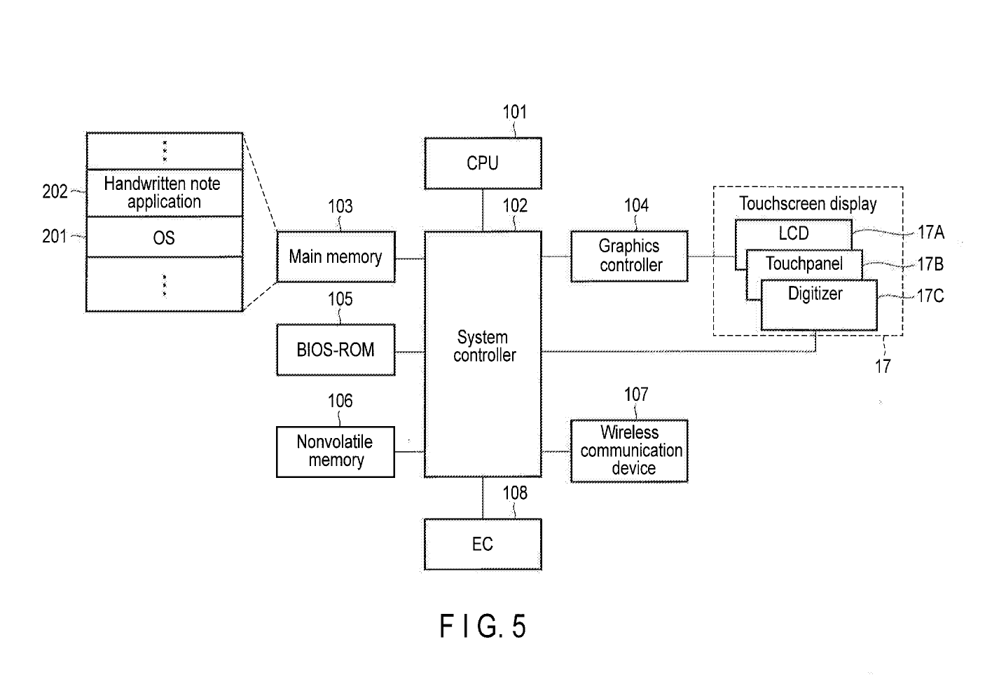

FIG. 5 shows a system configuration of the tablet computer 10.

The tablet computer 10 comprises, as shown in FIG. 5, a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor (hardware processor) configured to control the operations of various modules of the tablet computer 10. The CPU 101 executes various computer programs loaded from the nonvolatile memory 106 which is a storage device to the main memory 103. The programs include an operating system (OS) 201 and various application programs. The application programs include a handwritten note application program 202. For example, the handwritten note application program 202 has a function for creating and displaying the handwritten document described above, a function for editing a handwritten document and a handwriting-complete function for completing a stroke.

The CPU 101 executes a Basic Input/Output System (BIOS) stored in the BIOS-ROM 105. The BIOS is a program for hardware control.

The system controller 102 is a device which connects a local bus of the CPU 101 and various components. The system controller 102 comprises a built-in memory controller configured to control the access to the main memory 103. The system controller 102 has a function for communicating with the graphics controller 104 through a serial bus conforming to the PCI EXPRESS standard, etc.

The graphics controller 104 is a display controller (display control circuitry) configured to control an LCD 17A used as a display monitor of the tablet computer 10. A display signal generated by the graphics controller 104 is transmitted to the LCD 17A. The LCD 17A displays a screen image based on the display signal. A touchpanel 17B and a digitizer 17C are provided on the LCD 17A. The touchpanel 17B is a capacitive pointing device for inputting data on the screen of the LCD 17A. The touchpanel 17B detects the contact position of a finger on the screen, the movement of the contact position, etc. The digitizer 17C is an electromagnetic induction type of pointing device for inputting data on the screen of the LCD 17A. The digitizer 17C detects the contact position of the pen 100 on the screen, the movement of the contact position, etc.

The wireless communication device 107 is a device configured to perform wireless communication using, for example, a wireless LAN or 3G mobile communication. The EC 108 is a single-chip microcomputer including an embedded controller for power management. The EC 108 has a function for switching the tablet computer 10 on or off in response to the operation of the power button by the user.

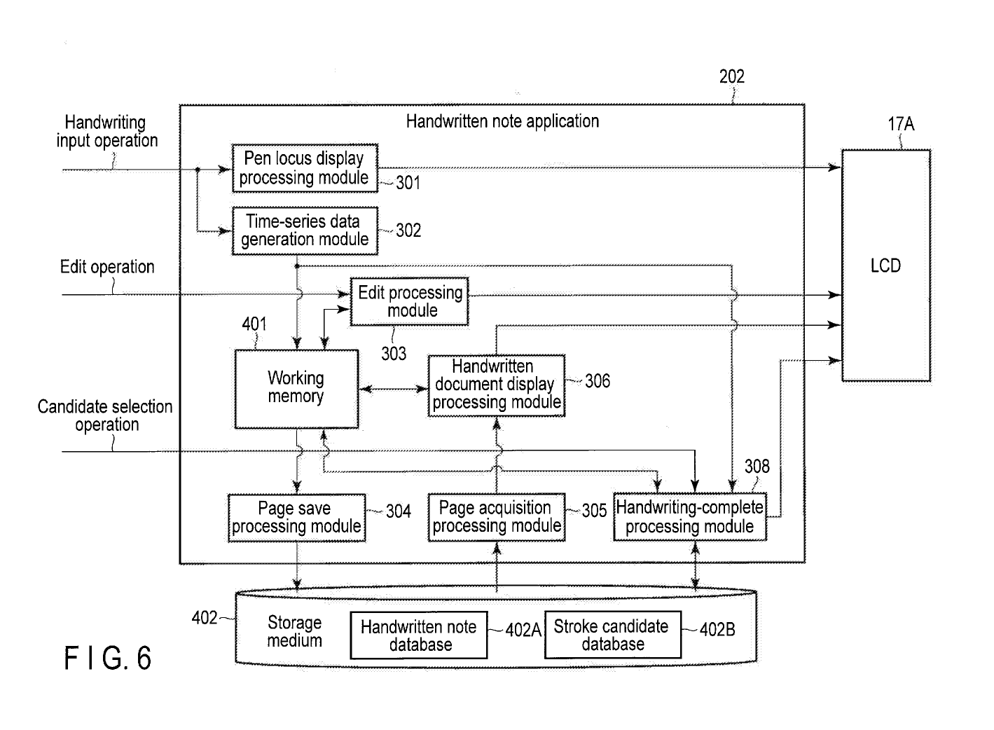

Now, this specification explains the function structure of the handwritten note application program 202 with reference to FIG. 6.

The handwritten note application program 202 comprises, for example, a pen locus display processing module 301, a time-series data generation module 302, an edit processing module 303, a page save processing module 304, a page acquisition processing module 305, a handwritten document display processing module 306 and a handwriting-complete processing module 308.

The handwritten note application program 202 creates, displays and edits a handwritten document (handwritten data) by using stroke data which is input with the touchscreen display 17. The touchscreen display 17 is capable of detecting a stroke made on the screen of the touchscreen display 17 and displaying the stroke on the screen. The touchscreen display 17 is configured to detect the generation of an event such as the event “touch”, “move (slide)” or “release”. The event “touch” is an event indicating that an external object comes in contact with the screen. The event “move (slide)” is an event indicating that the contact position is moved while the external object is in contact with the screen. The event “release” is an event indicating that the external object is separated from the screen. The handwritten note application program 202 displays a document such as the handwritten document and other electric documents on the screen.

The pen locus display processing module 301 and the time-series data generation module 302 receive the event “touch” or “move (slide)” generated by the touchscreen display 17 and detect a handwriting input operation by the reception. The event “touch” includes the coordinates of the contact position. The event “move (slide)” includes the coordinates of the contact position of the destination of the move. Thus, the pen locus display processing module 301 and the time-series data generation module 302 are capable of receiving the coordinate series corresponding to the locus of the movement of the contact position from the touchscreen display 17.

The pen locus display processing module 301 functions as a display processing module configured to detect strokes made on a display area of the document such as the handwritten page and display the stroke on the screen of the touchscreen display 17. The pen locus display processing module 301 receives a coordinate series from the touchscreen display 17. Based on the received coordinate series, the pen locus display processing module 301 displays a plurality of strokes which are input by handwriting with the pen 100, etc., on the screen of the LCD 17A of the touchscreen display 17.

The time-series data generation module 302 receives the aforementioned coordinate series output from the touchscreen display 17. Based on the received coordinate series, the time-series data generation module 302 generates a plurality of stroke data items (time-series data) corresponding to the plurality of strokes described above. These stroke data items may be temporarily stored in a working memory 401. In other words, the coordinates corresponding to each point of each stroke, and timestamp data of each stroke may be temporarily stored in the working memory 401.

The page save processing module 304 stores handwritten document data including a plurality of stroke data items corresponding to a plurality of strokes in a handwritten note database 402A of a storage medium 402. As stated above, the storage medium 402 may be any one of the storage device of the tablet computer 10, the storage device of the personal computer 1 and the storage device of the server 2.

The page acquisition processing module 305 reads arbitrary handwritten document data from the storage medium 402. The read handwritten document data is transmitted to the handwritten document display processing module 306. The handwritten document display processing module 306 analyzes the handwritten document data. The handwritten document display processing module 306 displays the loci of a plurality of strokes indicated by a plurality of stroke data items of the handwritten document data on the screen as a handwritten page, based on the result of analysis.

The edit processing module 303 performs a process for editing the handwritten document (handwritten page) which is displayed in progress. The edit processing module 303 performs an edit process for, for example, deleting or moving at least one of a plurality of strokes which are currently displayed in accordance with an edit operation performed by the user on the touchscreen display 17. The edit processing module 303 updates the handwritten document to reflect the result of the edit process on the handwritten document which is displayed in progress.

The user can delete an arbitrary one of a plurality of strokes which are displayed in progress, using the eraser tool, etc. The use can specify, as the range, an arbitrary portion of the handwritten page which is displayed in progress, using the range selection tool for surrounding an arbitrary portion of the screen with a circle or a rectangle.

The handwriting-complete processing module 308 is a processing module configured to perform the above handwriting-complete function for completing a stroke. The handwriting-complete processing module 308 determines at least one handwriting candidate from different handwriting stored in a memory (storage device), in response to an input of a stroke. The at least one handwriting candidate may be a stroke string such as a handwritten character string. The different handwriting may be the assembly of strokes (in other words, handwritten document data) which are input in the past. In the process for completing a stroke, for example, the handwriting-complete processing module 308 obtains one or more stroke strings (handwritten character strings) corresponding to the stroke which is input by handwriting from the assembly of strokes (in other words, handwritten document data) which are input in the past. The handwriting-complete processing module 308 performs a process for displaying the obtained stroke string or stroke strings on the screen as the handwriting candidates for strokes which are allowed to be entered (in other words, as stroke candidates).

In other words, the handwriting-complete processing module 308 predicts the stroke string (handwritten character string) which will be handwritten by the user based on the input stroke and handwritten document data. The handwriting-complete processing module 308 shows some stroke strings (handwritten character strings) obtained by the prediction as stroke candidates (handwritten character string candidates).

For example, when the stroke (or the handwritten character string) “a” is input by handwriting, the handwritten word “add” or “access” may be shown to the user as a handwriting candidate. User can select one of the handwriting candidates. The handwriting-complete processing module 308 receives a selection of a certain handwriting candidate from the handwriting candidates.

For example, when the user selects the handwritten word “access”, the handwriting-complete processing module 308 inputs the handwritten word “access” in as handwritten character string to be input in place of the stroke “a” to the displayed handwritten page (the displayed document). Thus, the user can easily input the stroke string of the handwritten word “access”.

The language of the handwritten character string stored in handwritten document data may be any language. The examples of available languages include English, Japanese, Chinese and other various languages. With regard to the English character string, the stroke string (handwritten character string) may be a stroke string corresponding to the character string in block letters, or may be a stroke string corresponding to the character string in cursive letters. In some cases, the word handwritten in cursive letters is composed of one stroke. Thus, the stroke string which is obtained from handwritten document data in a process for completing a stroke does not necessarily include a plurality of strokes and may be composed of only one stroke.

The examples of the stroke string corresponding to the input stroke include a plurality of strokes including a stroke similar to the input stroke, and one stroke including a stroke portion similar to the input stroke. For example, a stroke string in which the head stroke (or the head stroke portion) is similar to the input stroke is obtained from handwritten document data.

To easily obtain a stroke string corresponding to the input stroke from handwritten document data, the handwriting-complete processing module 308 may prepare a stroke candidate database 402B based on the assembly of strokes (handwritten document data) stored in the handwritten note database 402A.

For example, stroke strings (groups of stroke data items) and the results of character recognition (character strings) corresponding to the groups of stroke data items may be stored in the stroke candidate database 402B in the unit of a character string having a meaning, such as a word.

In this case, the handwriting-complete processing module 308 may recognize the stroke input by the user as a character. The handwriting-complete processing module 308 refers to the stroke candidate database 402B and discovers a character string whose prefix agrees with the result of character recognition (the character string) of the input stroke. The handwriting-complete processing module 308 obtains a stroke string (a group of stroke data items) corresponding to the discovered character string from the stroke candidate database 402B as a stroke string corresponding to the input stroke.

Alternatively, for example, stroke strings (groups of stroke data items) and the feature amount of each of the strokes corresponding to the groups of stroke data items may be stored in the stroke candidate database 402B in the unit of a character string having a meaning, such as a word. For the feature amount of a stroke, an arbitrary feature which can indicate the handwriting feature of the stroke may be used. For example, for the feature amount, the data of feature amount indicating the shape of the stroke, the writing direction of the stroke or the inclination of the stroke may be used. In this case, the handwriting-complete processing module 308 may obtain a stroke string having a feature amount similar to that of the input stroke from the stroke candidate database 402B.

Alternatively, for example, stroke strings (groups of stroke data items), the results of character recognition (character strings) corresponding to the groups of stroke data items, and the feature amount of each of the strokes corresponding to the groups of stroke data items may be stored in the stroke candidate database 402B in the unit of a character string having a meaning, such as a word.

The handwriting-complete processing module 308 predicts the stroke string which will be input by the user based on the input stroke and the stroke candidate database 402B. In this prediction process, the handwriting-complete processing module 308 obtains some stroke strings (handwritten character strings, etc.) corresponding to the input stroke from the stroke candidate database 402B. The handwriting-complete processing module 308 performs a process for displaying these stroke strings on the screen as the candidates for the handwritten character string which will be probably input (in other words, as the stroke candidates).

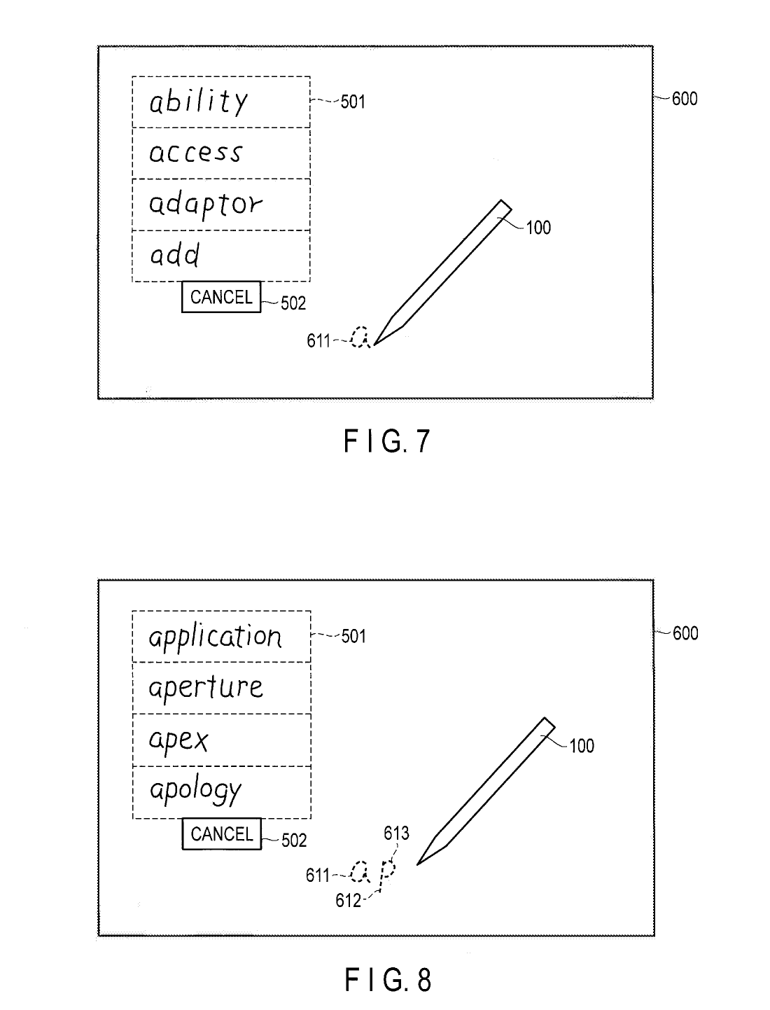

FIG. 7 shows examples of stroke candidates corresponding to the input stroke.

Here, it is assumed that stroke 611 corresponding to the handwritten character “a” is input by a handwriting input operation on an edit screen 600. The edit screen 600 is a screen used to create and edit a handwritten document (handwritten page).

When stroke 611 is input by handwriting, the handwriting-complete processing module 308 obtains some stroke strings (stroke candidates) corresponding to the input stroke 611 (here, the handwritten character “a”) from the stroke candidate database 402B. The handwriting-complete processing module 308 displays each of the stroke strings in a list of stroke candidates 501 on the edit screen 600.

The input stroke 611 is dealt with as an unconfirmed stroke (or a temporary stroke). An unconfirmed stroke indicates a stroke which has not been reflected on a handwritten page. An unconfirmed stroke is the stroke to be completed. A stroke candidate which is predicted based on the unconfirmed stroke is shown to the user. The input stroke 611 may be displayed in a color different from that of the pen which is currently selected, for example, red, such that stroke 611 is recognized by the user as an unconfirmed stroke (as a temporary stroke). In FIG. 7, the red stroke is shown by a broken line.

FIG. 7 assumes that four stroke strings are shown as stroke candidates in the list of stroke candidates 501. The four stroke strings include the handwritten character strings “ability”, “access”, “adaptor” and “add”.

Thus, some stroke strings (handwritten character strings) starting with the handwritten character “a” are shown to the user. These stroke strings are stroke strings (handwritten character strings) which were input in handwriting by the user in the past.

The handwriting-complete processing module 308 may display a cancel button 502 near the list of stroke candidates 501. The cancel button 502 functions as a confirm button for determining the input stroke (temporary stroke) as an entered stroke. An entered stroke indicates a stroke which has been reflected on a handwritten page. The stroke determined as an entered stroke is removed from the target to be completed.

FIG. 8 shows other examples of stroke candidates corresponding to the input strokes.

Here, it is assumed that strokes 612 and 613 corresponding to the handwritten character “p” are further input by a handwriting input operation on the edit screen 600 after the input of stroke 611 corresponding to the handwritten character “a”. In this case, the list of stroke candidates 501 is updated.

The handwriting-complete processing module 308 obtains some stroke strings (stroke candidates) corresponding to the input strokes 611, 612 and 613 (the handwritten character string “ap”) from the stroke candidate database 402B. The handwriting-complete processing module 308 displays each of the stroke strings in the list of stroke candidates 501 on the edit screen 600.

FIG. 8 assumes that four handwritten stroke strings which are the handwritten character strings “application”, “aperture”, “apex” and “apology” are shown as stroke candidates in the list of stroke candidates 501.

Thus, some handwritten character strings starting with “ap” are shown to the user.

When a stroke candidate is selected from the list of stroke candidates 501 by the user, the handwriting-complete processing module 308 displays a stroke string corresponding to the selected stroke candidate on the edit screen 600. In other words, the handwriting-complete processing module 308 completes the input handwritten strokes with a stroke string corresponding to the selected stroke candidate. In this manner, the user can easily input the desired word by merely inputting a part of the word by handwriting.

With regard to a character composed of a plurality of strokes, such as a Chinese character, the user can input the character by merely inputting a part of the plurality of strokes by handwriting.

With regard to a character string in cursive letters, the user can input a character string in cursive letters by merely inputting a part of the head of the stroke constituting the character string by handwriting.

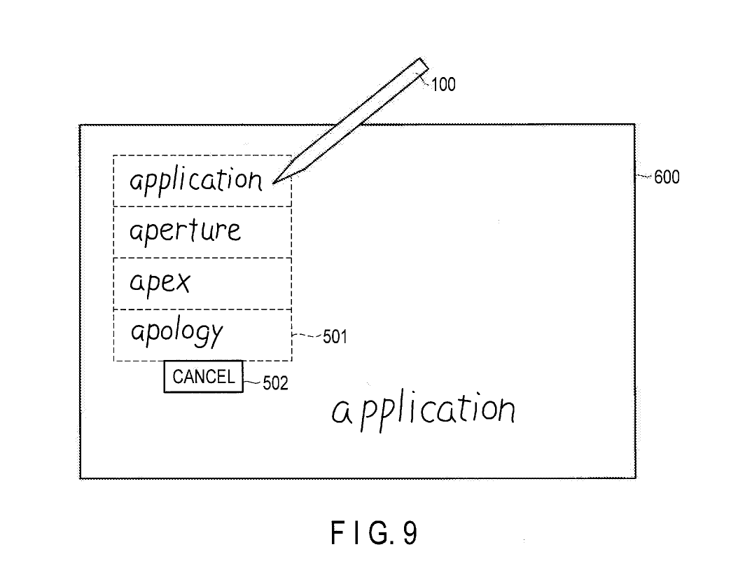

FIG. 9 shows an operation for completing the strokes which have been input by handwriting.

Here, it is assumed that the handwritten character string “application” is selected from the list of stroke candidates 501. When the handwritten character string “application” is tapped with the pen 100 or a finger, the handwriting-complete processing module 308 performs a process for displaying the selected handwritten character string “application” on the edit screen 600 in cooperation with the display processing module (the pen locus display processing module 301 or the handwritten document display processing module 306). In this case, the input strokes (strokes 611, 612 and 613 in FIG. 8) are completed with the selected handwritten character string “application”. In other words, the display processing module displays the selected handwritten character string “application” on the edit screen 600 in place of the input strokes (strokes 611, 612 and 613 in FIG. 8).

The selected handwritten character string “application” is determined as entered strokes and is reflected on the handwritten page which is edited in progress. The group of stroke data items of the handwritten character string “application” obtained from the stroke candidate database 402B is added to the handwritten page. When the handwritten character string “application” is a stroke string in cursive letters, one stroke data item corresponding to the handwritten character string “application” is added to the handwritten page.

In this manner, in the process for completing a stroke, some handwritten character strings corresponding to the stroke (temporary stroke) which is input by handwriting are shown to the user as stroke candidates. The selected stroke candidate (handwritten character string) is displayed on the edit screen 600 in place of the temporary stroke.

In this regard, since each stroke candidate is a stroke string (handwritten character string) which was input by handwriting in the past, the size or the character interval of each stroke candidate (handwritten character string) may be different from that of the character string to be written by the user. Thus, if the selected stroke candidate is simply displayed on the edit screen 600, the input stroke candidate (handwritten character string) may seem incongruous to the user in terms of size or character interval.

The size of the selected stroke candidate (handwritten character string) may be changed (in other words, the selected stroke candidate may be resized) in accordance with the size of the temporary stroke. However, the temporary stroke is replaced by the selected stroke candidate (handwritten character string). Thus, when a process for completing a stroke is performed, the handwritten character string followed by the selected stroke candidate is not the temporary strokes and is the handwritten character string which is input before the temporary strokes. Moreover, the size of the temporary strokes is not always equal to that of a handwritten character string which is input before the temporary strokes, for example, that of the handwritten character string immediately before the temporary strokes. Thus, it is difficult to appropriately resize the selected stroke candidate by means of the method for changing the size of the selected stroke candidate (handwritten character string) in accordance with the size of the temporary strokes.

In consideration of the above factors, in the present embodiment, the handwriting-complete processing module 308 is configured to determine a size of the selected stroke candidate (selected handwriting candidate) according to a size of a handwritten character string followed by the temporary stroke, and to input the selected handwriting candidate in place of the temporary stroke to the handwritten page on the edit screen 600 according to the first size. In other word, the handwriting-complete processing module 308 adjusts the size of the selected stroke candidate (handwritten character string) based on, instead of the size of the temporary strokes, the size of a handwritten character string which is input by handwriting before the input of the temporary strokes, for example, the size of the handwritten character string immediately before the temporary strokes. The handwriting-complete processing module 308 performs a process for displaying the selected stroke candidate (handwritten character string) on the edit screen 600 with a first size in place of the temporary strokes in cooperation with the display processing module described above. The first size is not determined in accordance with the size of the temporary strokes. Instead, the first size is determined in accordance with the size of the handwritten character string which is input by handwriting before the input of the temporary strokes.

The handwritten character string immediately before the temporary strokes may be a handwritten character string which is already input in the same line as the line in which the temporary strokes are input. When the temporary strokes are located in the head of the line, a handwritten character string which is already input in the line one line before the line of the temporary strokes may be used as the handwritten character string immediately before the temporary strokes.

Further, the handwriting-complete processing module 308 may adjust the character interval of the selected stroke candidate (handwritten character string) in accordance with the character interval of a handwritten character string which is input by handwriting before the input of the temporary strokes, for example, the character interval of the handwritten character string immediately before the temporary strokes.

Thus, in the present embodiment, the size and the character interval of the selected stroke candidate (handwritten character string) are adjusted based on a handwritten character string which is input by handwriting before the input of the temporary strokes. The stroke candidate having the adjusted size and character interval are displayed by the display processing module on the edit screen 600 in place of the temporary strokes. In this manner, the selected stroke candidate can be input to the page with a size and a character interval as expected to some extent without relying on the original size or the original character interval of the selected stroke candidate.

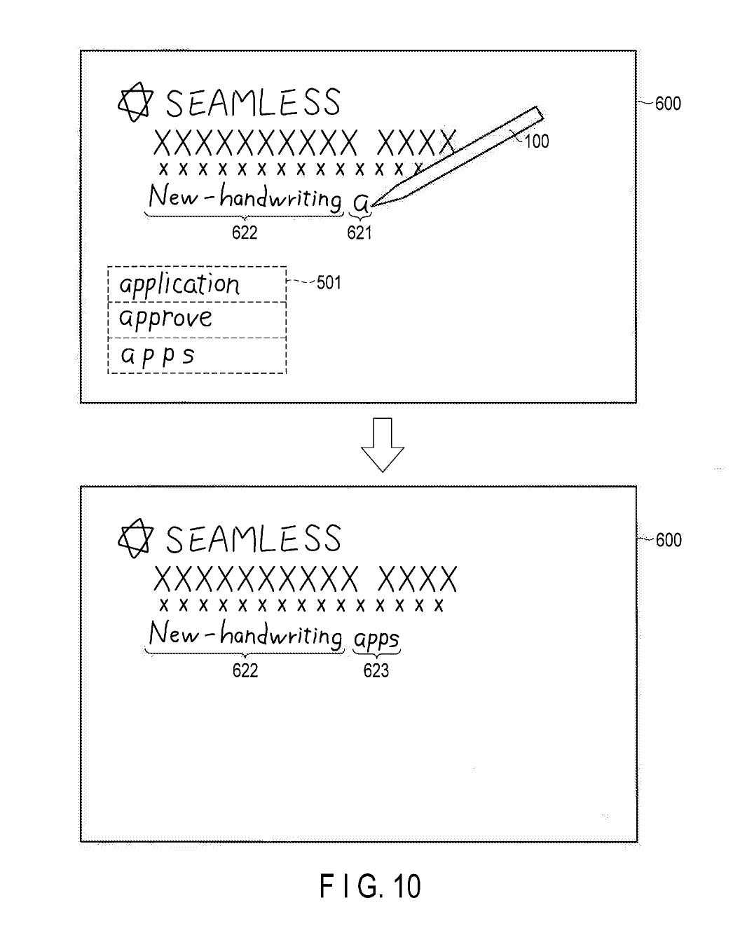

FIG. 10 shows an operation for adjusting the size and the character interval of the selected stroke candidate (handwritten character string).

Here, it is assumed that stroke 621 corresponding to the handwritten character “a” is input by handwriting. In this case, the handwriting-complete processing module 308 obtains, from the stroke candidate database 402B, some stroke candidates (handwritten character strings) corresponding to stroke 621. The handwriting-complete processing module 308 performs a process for displaying the stroke candidates in the list of stroke candidates 501 on the edit screen 600.

FIG. 10 assumes that three handwritten stroke strings which are the handwritten character strings “application”, “approve” and “apps” are shown as stroke candidates in the list of stroke candidates 501.

If the handwritten character string “apps” is selected by the user, the handwriting-complete processing module 308 adjusts the size of the handwritten character string “apps”. The size of the handwritten character string “apps” is adjusted based on the size of a handwritten character string which is input by handwriting before stroke 621 (here, based on the size of a handwritten character string “New-handwriting” 622). The handwritten character string “New-handwriting” 622 is an entered stroke string which is excluded from the target to be completed. The process for adjusting the size of the handwritten character string “apps” includes a process for adjusting the height of the handwritten character string “apps” in accordance with the height of the handwritten character string “New-handwriting” 622. The handwriting-complete processing module 308 may scale the handwritten character string “apps” such that the height of the handwritten character string “apps” is substantially equal to that of the handwritten character string “New-handwriting” 622.

The handwriting-complete processing module 308 may adjust the character interval of the handwritten character string “apps” based on the character interval of the handwritten character string “New-handwriting” 622. In this case, the character interval of the handwritten character string “apps” may be changed so as to be substantially equal to the average character interval of the handwritten character string “New-handwriting” 622.

The handwriting-complete processing module 308 determines a handwritten character string “apps” 623 having the adjusted size and character interval as an entered handwritten character string. The handwriting-complete processing module 308 displays the handwritten character string “apps” 623 having the adjusted size and character interval on the edit screen 600 in place of stroke 621. In this case, the handwriting-complete processing module 308 may determine the start position of an area on the handwritten page (document) in which the handwritten character string “apps” is input according to the position of stroke 621 on the handwritten page.

In other word, the handwriting-complete processing module 308 may adjust the start position of the handwritten character string “apps” on the edit screen 600 in accordance with the position of stroke 621 on the edit screen 600. The start position of the handwritten character string “apps” on the edit screen 600 indicates the start position of the area in which the handwritten character string “apps” should be displayed on the edit screen 600.

The handwritten character string “apps” 623 follows the handwritten character string “New-handwriting” 622. The size and the character interval of the handwritten character string “apps” 623 match the size and the character interval of the handwritten character string “New-handwriting”. Thus, a feeling of incongruity is not caused by the difference in the size or the character interval between the handwritten character string “apps” 623 and the character string immediately before the handwritten character string “apps” 623. In this manner, the selected handwritten character string “apps” 623 can be input smoothly to the page.

When stroke 621 is the head handwritten character of the line, the size and the character interval of the handwritten character string “apps” 623 may be adjusted based on the size and the character interval of the handwritten character string of the line one line above the line of stroke 621.

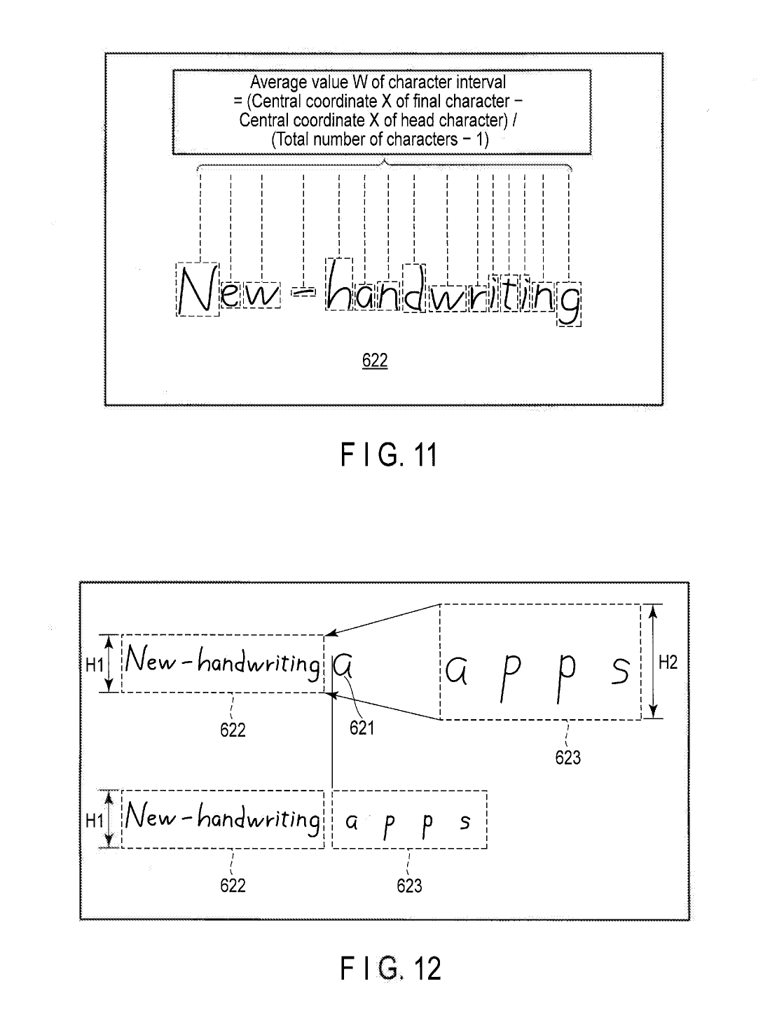

FIG. 11 shows an operation for calculating the average character interval (the average value of the character interval) of the handwritten character string “New-handwriting” 622.

The average character interval W of the handwritten character string “New-handwriting” 622 can be calculated, using the following expression:

W=(Central coordinate X of final character−Central coordinate X of head character)/(Total number of characters−1)

Here, the central coordinate X of the final character indicates the X-coordinate of the center of the circumscribed rectangle of the final character. The central coordinate X of the head character indicates the X-coordinate of the center of the circumscribed rectangle of the head character.

FIG. 12 shows an operation for adjusting the size and the start position of the selected stroke candidate. The size and the start position of the selected stroke candidate (here, the handwritten character string “apps” 623) are adjusted as follows.

The handwriting-complete processing module 308 firstly adjusts the size of the handwritten character string “apps” 623 by scaling up or down the handwritten character string “apps” 623 such that height H2 of the handwritten character string “apps” 623 is equal to height H1 of the handwritten character string “New-handwriting” 622. In this case, the handwriting-complete processing module 308 may define the rectangle surrounding the handwritten character string “apps” 623, assuming that the handwritten character string “apps” 623 is a character string having both ascender and descender. The handwriting-complete processing module 308 may define the rectangle surrounding the handwritten character string “New-handwriting” 622 in the same manner. The handwriting-complete processing module 308 scales up or down the handwritten character string “apps” 623 such that height H2 of the rectangle corresponding to the handwritten character string “apps” 623 is equal to height H1 of the rectangle corresponding to the handwritten character string “New-handwriting” 622. The handwritten character string “apps” 623 may be scaled up or down in a state where the aspect ratio of the handwritten character string “apps” 623 is maintained.

The display position of the handwritten character string “apps” 623 on the edit screen is determined in the following manner: the start position of the handwritten character string “apps” 623 conforms to the position of temporary stroke 621, and further, the position of the lower side of the rectangle corresponding to the handwritten character string “apps” 623 is located in the position of the lower side of the rectangle corresponding to the handwritten character string “New-handwriting” 622.

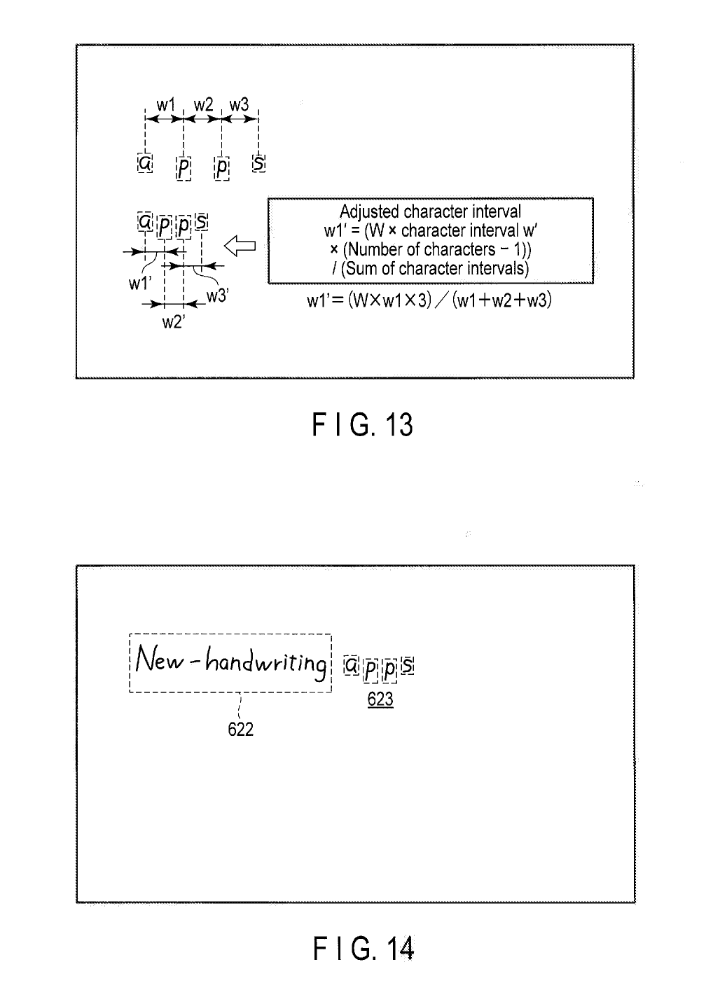

FIG. 13 shows an operation for adjusting the character interval of the selected stroke candidate. The adjusted character interval of the stroke candidate (here, the handwritten character string “apps” 623) is determined, using the above average character interval W. For example, adjusted character interval w1′ between “a” and “p” can be calculated by the following expression:

w1′=(W×w1×3)/(w1+w2+w3)

Here, w1 is the unadjusted character interval between “a” and “p”; w2 is the unadjusted character interval between “p” and “p”; and w3 is the unadjusted character interval between “p” and “s”.

Adjusted character interval w2′ between “p” and “p” and adjusted character interval w3′ between “p” and “s” can be calculated in the same manner as w1′. The handwritten character string “apps” 623 is displayed in the adjusted character interval as shown in FIG. 14.

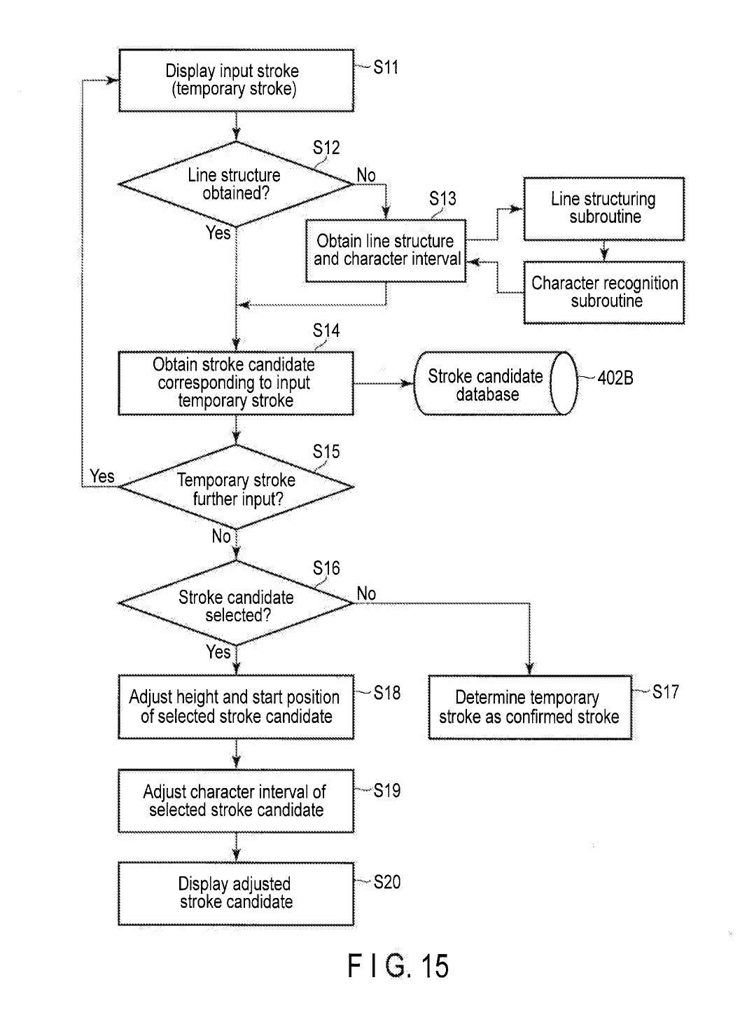

FIG. 15 is a flowchart showing the procedure of the above process for completing a stroke.

When the user inputs a stroke by a handwriting input operation, the pen locus display processing module 301 displays the input stroke (temporary stroke) on the screen (step S11). The handwriting-complete processing module 308 receives stroke data corresponding to the input stroke from the time-series data generation module 302. The handwriting-complete processing module 308 determines whether or not the data of the line structure (handwritten character string) which is the base for adjusting a stroke candidate has been already obtained (step S12).

When the data related to the line structure (handwritten character string) has not been obtained (NO in step S12), the handwriting-complete processing module 308 proceeds to step S13. In step S13, the handwriting-complete processing module 308 performs a process for specifying the line structure (handwritten character string) which is the base for adjusting a stroke candidate and a process for obtaining the character interval of the line structure (handwritten character string). In this case, the handwriting-complete processing module 308 firstly analyzes the line structure of the whole handwritten document (page) on the edit screen 600, using a line structuring subroutine. The handwriting-complete processing module 308 specifies the line in which the temporary stroke is input. The handwriting-complete processing module 308 obtains, as the base line structure, a handwritten character string in the line in which the temporary stroke is input, in other words, data related to a handwritten character string which is input before the input of the temporary stroke. When the temporary stroke is located in the head of the line, a handwritten character string in the line one line above the line of the temporary stroke may be specified as the base line structure. Subsequently, the handwriting-complete processing module 308 applies a process for recognizing a character to the specified line structure (handwritten character string), using a character recognition subroutine. In this manner, the handwriting-complete processing module 308 obtains the result of character recognition of the specified handwritten character string, and the data of the circumscribed rectangle of each handwritten character of the specified handwritten character string. The handwriting-complete processing module 308 further obtains the average character interval W of the specified handwritten character string, using the data of the circumscribed rectangle of each handwritten character, etc.

The handwriting-complete processing module 308 obtains a handwritten character string (stroke candidate) corresponding to the input temporary stroke from the stroke candidate database 402B (step S14). The process of step S14 is equivalent to a process for predicting the handwritten stroke string (handwritten character string) which will be input by the user based on the input temporary stroke and the stroke candidate database 402B. The handwriting-complete processing module 308 displays a list of stroke candidates, in other words, the list of stroke candidates 501, on the screen in cooperation with the above display processing module. Some handwritten character strings are displayed in the list of stroke candidates 501. When a new temporary stroke is further input (YES in step S15), the handwriting-complete processing module 308 obtains, from the stroke candidate database 402B, a handwritten character string (stroke candidates) corresponding to the combination of the temporary stroke which is firstly input and the new temporary stroke.

The handwriting-complete processing module 308 determines whether or not a handwritten character string (stroke candidate) is selected by the user (step S16). When the user does not select any handwritten character string (stroke candidate) and taps the cancel button 502 (NO in step S16), the handwriting-complete processing module 308 determines the input temporary stroke as an entered stroke (confirmed stroke string) (step S17). In step S17, the handwriting-complete processing module 308 deletes the list of stroke candidates 501 from the screen.

When a handwritten character string (stroke candidate) is selected (YES in step S16), the handwriting-complete processing module 308 adjusts the size (height) of the selected handwritten character string and the start position of the selected handwritten character string based on the height of the specified line structure and the display position of the temporary stroke (step S18). The handwriting-complete processing module 308 adjusts the character interval of the selected handwritten character string, using the average character interval W (step S19). The handwriting-complete processing module 308 displays the selected handwritten character string having the adjusted size and character interval on the edit screen in place of the temporary stroke in cooperation with the above display processing module (step S20). In step S20, the input temporary stroke is replaced by the stroke string of the selected handwritten character string. The stroke string of the selected handwritten character string is determined as an entered stroke (confirmed stroke) and is reflected on the handwritten page which is currently prepared or edited.

As explained above, in the present embodiment, a stroke (first stroke) made on a display area of the document displayed on the screen of the touchscreen display 17 is detected and the first stroke is displayed on the screen. At least one handwritten candidate is determined from the different handwriting stored in the memory (storage device) of the tablet computer 10 in response to the input of the first stroke. When a selection of a first handwritten candidate from the at least one handwritten candidate character is received, a size (first size) of the first handwritten candidate is determined according to the size of a second handwritten character string followed by the first stroke. And the first handwriting candidate is input in place of the first stroke to the document according to the first size.

In other word, The size of the first handwriting such as a handwritten character string is adjusted based on, instead of the size of the first stroke, the size of a second handwritten character string which is input by handwriting before the input of the first stroke. Thus, the selected first handwriting candidate can be input smoothly without causing a feeling of incongruity because of the difference in the size between the selected first handwriting candidate and the handwritten character string which has been already input.

A character interval of handwritten characters included in the first handwritten candidate may be determined according to a character interval of the second handwritten character string.

In this case, the first handwritten candidate in which both the size and the character interval are adjusted may be input to the document in place of the first stroke.

Each process of the present embodiment can be realized by a computer program. Therefore, an effect similar to that of the present embodiment can be easily realized by merely installing the computer program on a computer through a computer-readable recording medium in which the computer program is stored and executing the computer program.

The CPU of the computer on which the computer program is installed can function as a hardware processor configured to perform the above process for complementing a stroke. The GPU of the computer can function as a display control circuitry configured to display each stroke on the screen.

In the present embodiment, it is assumed that a tablet computer is used. However, the function for processing a handwritten document in the present embodiment may be also applied to a normal desktop computer. In this case, for example, a table which is the input device for handwriting input may be connected to a desktop computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display capable of detecting a stroke made on a screen of the display and displaying the stroke on the screen;
a memory configured to store different handwriting; and
a hardware processor configured to:
display a first document on the screen;
detect a first stroke made on a display area of the first document;
display the first stroke on the screen;
determine at least one handwriting candidate from the different handwriting in response to an input of the first stroke;
display the at least one handwriting candidate on the screen;
receive a selection of a first handwriting candidate from the at least one handwriting candidate;
determine a first size of the first handwriting candidate according to a size of a second handwritten character string followed by the first stroke; and
input the first handwriting candidate in place of the first stroke to the first document according to the first size.

2. The electronic device of claim 1, wherein
a character interval of handwritten characters included in the first handwritten candidate is determined according to a character interval of the second handwritten character string.

3. The electronic device of claim 1, wherein
the second handwritten character string is a handwritten character string immediately before the first stroke.

4. The electronic device of claim 1, wherein
a start position of an area on the first document in which the first handwritten candidate is input is determined in accordance with a position of the first stroke on the document.

5. The electronic device of claim 1, wherein
the first handwritten candidate of the first size has a first height which is determined according to a height of the second handwritten character string.

6. A method comprising:
displaying a first document on a screen of a display;
detecting a first stroke made on a display area of the first document;
displaying the first stroke on the screen;
determining at least one handwriting candidate from different handwriting stored in a memory in response to an input of the first stroke;
displaying the at least one handwriting candidate on the screen;
receiving a selection of a first handwriting candidate from the at least one handwriting candidate;
determining a first size of the first handwriting candidate according to a size of a second handwritten character string followed by the first stroke; and
inputting the first handwriting candidate in place of the first stroke to the first document according to the first size.

7. The method of claim 6, wherein
a character interval of handwritten characters included in the first handwritten candidate is determined according to a character interval of the second handwritten character string.

8. The method of claim 6, wherein
the second handwritten character string is a handwritten character string immediately before the first stroke.

9. The method of claim 6, wherein
a start position of an area on the first document in which the first handwritten candidate is input is determined in accordance with a position of the first stroke on the document.

10. The method of claim 6, wherein
the first handwritten candidate of the first size has a first height which is determined according to a height of the second handwritten character string.
